(19) United States
(12) Patent Application Publication
(10) Pub. No.: US 2023/0287294 A1
(43) Pub. Date: Sep. 14, 2023

(54) PROCESS AND APPARATUS FOR PRODUCING PRETREATED OIL OR FAT PRODUCT FROM CRUDE OIL OR FAT FEEDSTOCK COMPRISING A POLYMER

(71) Applicant: L'Air Liquide Société Anonyme pour l'Etude et l'Exploitation des Procédés Georges Claude, Paris (FR)

(72) Inventors: Mrityunjoy SAMADDAR, Frankfurt am Main (DE); Ulrike STREIBER, Frankfurt am Main (DE)

(21) Appl. No.: 18/121,291

(22) Filed: Mar. 14, 2023

(30) Foreign Application Priority Data
Mar. 14, 2022 (EP) 22020108.1

(51) Int. Cl. C11B 3/00; C11B 3/04

(52) U.S. Cl. CPC C11B 3/001; C11B 3/04; C11B 3/008

(57) ABSTRACT

A process for producing a pretreated oil or fat product from a crude oil or fat feedstock including a polymer, is provided. The process includes providing the crude oil or fat feedstock including a polymer from a storage volume; subjecting the crude oil or fat feedstock to a degumming step to obtain a degummed oil or fat feedstock; subjecting the degummed oil or fat feedstock to a bleaching step to obtain a bleached oil or fat feedstock; and routing out the bleached oil or fat feedstock from the bleaching step as the pretreated oil or fat product. The process also includes a polymer removal step, performed on the oil and fat feedstock upstream of any of the process steps (for producing polymer depleted oil or fat feedstock.

### CROSS REFERENCE TO RELATED APPLICATIONS

This application claims the benefit of priority under 35 U.S.C. § 119 (a) and (b) to European Patent Application No. 20220108.1, filed Mar. 14, 2022, the entire contents of which are incorporated herein by reference.

### TECHNICAL FIELD

The present disclosure relates generally to a process for pretreating various feedstocks to remove polymers; more specifically, the present disclosure relates to a process and an apparatus for producing a pretreated oil or fat product from a crude oil or fat feedstock comprising a polymer.

### BACKGROUND

The pretreatment of various oils and fats of biological origin as typical feedstocks for renewable fuel plants (e.g. renewable diesel obtained by hydrotreating these oils and fats) comprises physical and/or chemical refining process steps or unit operations which are per se known from the prior art, e.g. from Ullmann's Encyclopedia of Industrial Chemistry, Sixth Edition, 1998 Electronic Release, FATS AND FATTY OILS—Chapter 6: Refining (Alfred Thomas).

This pretreatment typically includes at least one of acid/water-degumming for removing phosphorus/gums, bleaching for removing metals, sulphur, etc. or deodorizing/stripping unit for removing free fatty acids. A separate or dedicated unit for polymer removal is typically not included. The conventional steps as mentioned above, e.g. degumming or bleaching, may remove polymer particles to some extent present in the crude feeds, however not necessarily to the extent as desired.

An existing solution discloses pretreatment for renewable diesel (e.g. Hydrotreated Vegetable Oil, HVO) process that includes polyethylene (PE) removal. However, the process as described in this existing solution is state of the art of degumming and bleaching which are common process along with removing other impurities from same steps. However, no separate dedicated process is provided for polymer-removal.

Another existing solution discloses production of renewable diesel (HVO) including the main hydrogenation step, and without detailing on the pretreatment steps. In general, the pretreatment is mentioned only as a pre-step before the main hydrogenation step. However, specific details of PE-removal are not disclosed in the process of this existing solution.

There are numerous disadvantages and problems associated with the existing solutions for polymer (e.g. PE) removal. Firstly, some fat feedstocks like some animal fats have very high amount of polymers present. For example, polyethylene (PE) content in some animal fat feeds may be >100 weight-parts per million (wt.-ppm) of PE. Sometimes, the polyethylene (PE) content in some animal fat may be up to 1000 wt.-ppm PE and more. With the conventional process of degumming and bleaching, it is very difficult to reduce the polyethylene content from such very high amount of polymers. The typical required specification may be <50 wt.-ppm PE or even <20 wt.-ppm PE after treatment, before the feed is fed to a downstream renewable fuel or a HVO plant.

Secondly, if the conventional process (i.e. degumming and bleaching) is used, the filtered polymer particles are obtained as a filter cake from the bleaching process, which also has the oil content in it, as well as other impurities removed in the bleaching process. From the filter cake, it is much more difficult to recover the oil. Thirdly, another problem with the existing solution is related to the possible application of the filter cake. One of the applications of the filter cake (after oil recovery) is to use it in animal feed blends. But if this filter cake contains the polymer particles as mentioned above, then it is not feasible to use this as animal feed.

Therefore, there is a need to address aforementioned technical drawbacks in existing known technologies for producing a polymer depleted pretreated oil or fat product.

### SUMMARY

The present disclosure seeks to provide an improved approach for production of a polymer depleted pretreated oil or fat product from a crude oil or fat feedstock. An aim of the present disclosure is to provide a solution that overcomes at least partially the problems encountered in the prior art and to provide a process and an apparatus for producing the pretreated oil or fat product from the crude oil or fat feedstock comprising a polymer. The process performs the removal of polymers (e.g. polyethylene) which is present in the oil or fat feedstock; thereby reducing maintenance requirement and reducing plant shutdowns or downtime in downstream units. The process employs a separate polyethylene (PE) removal to achieve low level of polyethylene (e.g. <50 wt. ppm PE or <20 wt. ppm PE). The object of the present disclosure is achieved by the solutions provided in the enclosed independent claims, Advantageous implementations of the present disclosure are further defined in the enclosed dependent claims.

According to a first aspect, the present disclosure provides a process for producing a pretreated oil or fat product from a crude oil or fat feedstock comprising a polymer, the process comprising the following steps:
(a) providing the crude oil or fat feedstock comprising a polymer from a storage volume;
(b) subjecting the crude oil or fat feedstock to a degumming step to obtain a degummed oil or fat feedstock by contacting the crude oil or fat feedstock with at least one degumming agent under degumming conditions;
(c) subjecting the degummed oil or fat feedstock to a bleaching step to obtain a bleached oil or fat feedstock by contacting the degummed oil or fat feedstock with at least one bleaching agent under bleaching conditions;
(d) routing out the bleached oil or fat feedstock from the bleaching step as the pretreated oil or fat product; and characterized in that the process further comprises a polymer removal step (e), performed on the oil and fat feedstock upstream of any of the process steps (a), (b), (c), (d), wherein the polymer removal step comprises the substeps of:
(e1) subjecting the oil or fat feedstock to a cooling step to obtain a cooled oil or fat feedstock;
(e2) adding at least one filter aid chemical to the cooled oil or fat feedstock to obtain a cooled filter aid comprising oil or fat feedstock;
(e3) subjecting the cooled filter aid comprising oil or fat feedstock to a filtering step to obtain a polymer depleted oil or fat feedstock; and
(e4) routing out the polymer depleted oil or fat feedstock and introducing the polymer depleted oil or fat feedstock into any of the downstream process steps (a), (b), (c), (d).

The process for producing the pretreated oil or fat product rom the crude oil or fat feedstock comprising the polymer according to present disclosure is of advantage in that the process performs the removal of polymers (e.g. polyethylene) which is present in the oil or fat feedstock, thereby reducing maintenance requirement and reducing plant shutdown/downtime in downstream units. Further, the process employs a separate polyethylene (PE) removal to achieve low level of polyethylene (e.g. <50 wt. ppm PE or <20 wt. ppm PE). The process with the separate polymer-removal enables the reuse of filter cake (e.g. a bleaching earth filter cake) without contaminating the polymer depleted oil or fat feedstock with polymer by again dissolving the polymer into the crude oil or fat feedstock. The process is a flexible process as it can be easily implemented or performed either at an upstream or at a downstream of pretreatment process (e.g. at degumming and bleaching steps).

According to a second aspect, the present disclosure provides an apparatus for producing a pretreated oil or fat product from a crude oil or fat feedstock comprising a polymer, wherein the apparatus comprises:
(a) a storage volume and means for providing the crude oil or fat feedstock comprising a polymer from the storage volume;
(b) means for subjecting the crude oil or fat feedstock to a degumming step to obtain a degummed oil or fat feedstock by contacting the crude oil or fat feedstock with at least one degumming agent under degumming conditions;
(c) means for subjecting the degummed oil or fat feedstock to a bleaching step to obtain a bleached oil or fat feedstock by contacting the degummed oil or fat feedstock with at least one bleaching agent under bleaching conditions;
(d) means for routing out the bleached oil or fat feedstock from the bleaching step as the pretreated oil or fat product, and

characterized in that the apparatus further comprises means for performing a polymer removal step (e), performed on the oil and fat feedstock upstream of any of the process steps (a), (b), (c), (d), wherein the means for performing the polymer removal step comprise the following elements:
(e1) means for subjecting the oil or fat feedstock to a cooling step to obtain a cooled oil or fat feedstock,
(e2) means for adding at least one filter aid chemical to the cooled oil or fat feedstock to obtain a cooled filter aid comprising oil or fat feedstock,
(e3) means for subjecting the cooled filter aid comprising oil or fat feedstock to a filtering step to obtain a polymer depleted oil or fat feedstock, and
(e4) means for routing out the polymer depleted oil or fat feedstock and means for introducing the polymer depleted oil or fat feedstock into any of the means for performing a downstream process step (a), (b), (c) or (d).

The apparatus for producing the pretreated oil or fat product from the crude oil or fat feedstock comprising the polymer according to present disclosure is of advantage in that the apparatus performs the removal of polymers (e.g. polyethylene) which is present in the oil or fat feedstock, thereby reducing maintenance requirement and reducing plant shutdown or downtime in downstream units. Further, the apparatus employs a separate polyethylene (PE) removal unit to achieve low level of polyethylene (e.g. <50 wt. ppm PE or <20 wt. ppm PE). The apparatus with the separate polymer-removal unit enables the reuse of filter cake (e.g. a bleaching earth filter cake) without contaminating the polymer depleted oil or fat feedstock with polymer by again dissolving the polymer into the crude oil or fat feedstock. The apparatus is a flexible as it can be easily implemented either at an upstream or at a downstream of pretreatment plant (e.g. at degumming and bleaching steps).

Embodiments of the present disclosure eliminate the aforementioned drawbacks in existing known approaches for producing a polymer depleted pretreated oil or fat product from the crude oil or fat feedstock comprising the polymer. The advantage of the embodiments according to the present disclosure is that the embodiments enable to produce the polymer depleted pretreated oil or fat product from the crude oil or fat feedstock comprising the polymer. The embodiments of the present disclosure perform the removal of polymers (e.g. polyethylene) which is present in the oil or fat feedstock, thereby reducing maintenance requirement and reducing plant shutdown or downtime in the downstream units. Embodiments of the present disclosure have a separate polyethylene (PE) removal to achieve low level of polyethylene (e.g. <50 wt. ppm PE or <20 wt. ppm PE).

Additional aspects, advantages, features and objects of the present disclosure are made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. To illustrate the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, the same elements have been indicated by identical numbers. Embodiments of the present disclosure will now be described, by way of example only, with reference to the following diagrams wherein:

FIG. 1 illustrates a block diagram of an apparatus having a polymer removal means in upstream of a degumming means for producing a pretreated oil or fat product from a crude oil or fat feedstock comprising a polymer according to an embodiment of the present disclosure;

FIG. 2 illustrates a block diagram of an apparatus having a polymer removal means in downstream of a bleaching means for producing a pretreated oil or fat product from a crude oil or fat feedstock comprising a polymer according to an embodiment of the present disclosure;

FIG. 3(i) is a flowchart illustrating a process for producing a pretreated oil or fat product from a crude oil or fat feedstock comprising a polymer according to an embodiment of the present disclosure; and

FIG. 3(ii) is a flowchart illustrating a process for producing a pretreated oil or fat product from a crude oil or fat feedstock comprising a polymer according to an embodiment of the present disclosure.

### DEFINITIONS

The conditions required for performing the following standard oil or fat processing operations: degumming, bleaching, free fatty acid (FFA) removal, oil splitting, polyethylene removal, are known to the skilled person from the prior art. These are the physicochemical conditions under which a measurable, at least partial, preferably an industrially relevant, conversion of a crude oil or fat the corresponding processed oil or fat product is achieved. Necessary adjustments of these processing conditions to the respective operational requirements will be made on the basis of routine experiments. Any specific reaction conditions disclosed may serve here as a guide, but they should not be regarded as limiting in relation to the scope of the invention.

### Specifically:

The term “degumming step” is to be understood as meaning a pretreatment process step that involves at least partial or full removal of gums, resins, proteins, phosphorus-containing compounds and other impurities from the crude oil or fat feedstock.

The term “degummed oil or fat feedstock” is to be understood as meaning a refined oil or fat feedstock that is depleted in gums, resins, proteins, phosphorus-containing compounds and other impurities by the degumming step.

The term “degumming agent” is to be understood as meaning any agent such as physical; chemical, or biological agent used in the degumming step to remove the gums, resins, proteins, phosphorus-containing compounds and other impurities from the crude oil or fat feedstock.

The term “degumming conditions” is to be understood as meaning process conditions such temperature, pressure, p^{H} etc, under such conditions the degumming step is performed.

The term “bleaching step” is to be understood as meaning a pretreatment process step that involves at least partial or full removal of pigments, metals, and phosphorus-containing compounds from the crude oil or fat feedstock.

The term “bleached oil or fat feedstock” is to be understood as meaning a refined oil or fat feedstock that is at least partially or fully depleted in pigments, metals, and phosphorus-containing compounds by bleaching step.

The term “bleaching agent” is to be understood as meaning any agent such as physical, chemical, or biological agent used in the bleaching step to remove the pigments, metals, and phosphorus-containing compounds from the crude oil or fat feedstock.

The term “polymer removal step” is to be understood as meaning a pretreatment process step that involves removal of polymer from the crude oil or fat feedstock.

The term “polymer removal conditions” is to be understood as meaning process conditions such temperature, pressure, p^{H} etc. under such conditions the polymer removal step is performed.

The term “polymer depleted oil or fat feedstock” is to be understood as meaning a refined oil or fat feedstock that is depleted in polymer (e.g. polyethylene) by the polymer removal step.

Optional or optionally means that the subsequently described event or circumstances may or may not occur. The description includes instances where the event or circumstance occurs and instances where it does not occur.

“Providing or subjecting” in a claim is defined to mean furnishing, supplying, making available, or preparing something. The step may be performed by any actor in the absence of express language in the claim to the contrary.

Pressure indications are in bar, absolute, bar (a) or bars for short, unless otherwise stated in the particular context.

### DETAILED DESCRIPTION OF PREFERRED EMBODIMENTS

The following detailed description illustrates embodiments of the present disclosure and ways in which they can be implemented. Although some modes of carrying out the present disclosure have been disclosed; those skilled in the art would recognize that other embodiments for carrying out or practicing the present disclosure are also possible.

According to a first aspect, the present disclosure provides a process for producing a pretreated oil or fat product from a crude oil or fat feedstock comprising a polymer, the process comprising the following steps:
(a) providing the crude oil or fat feedstock comprising a polymer from a storage volume;
(b) subjecting the crude oil or fat feedstock to a degumming step to obtain a degummed oil or fat feedstock by contacting the crude oil or fat feedstock with at least one degumming agent under degumming conditions;
(c) subjecting the degummed oil or fat feedstock to a bleaching step to obtain a bleached oil or fat feedstock by contacting the degummed oil or fat feedstock with at least one bleaching agent under bleaching conditions;
(d) routing out the bleached oil or fat feedstock from the bleaching step as the pretreated oil or fat product; and

characterized in that the process further comprises a polymer removal step (e), performed on the oil and fat feedstock upstream of any of the process steps (a), (b), (c), (d), wherein the polymer removal step comprises the substeps of:
(e1) subjecting the oil or fat feedstock to a cooling step to obtain a cooled oil or fat feedstock;
(e2) adding at least one filter aid chemical to the cooled oil or fat feedstock to obtain a cooled filter aid comprising oil or fat feedstock;
(e3) subjecting the cooled filter aid comprising oil or fat feedstock to a filtering step to obtain a polymer depleted oil or fat feedstock; and
(e4) routing out the polymer depleted oil or fat feedstock and introducing the polymer depleted oil or fat feedstock into any of the downstream process steps (a), (b), (c), (d).

The process performs the removal of polymers (e.g. polyethylene) which is present in the oil or fat feedstock, thereby reducing maintenance requirement and reducing plant shutdown/downtime in downstream units. If this polymer is not removed, then it may cause plugging problems in internals (for example, in the packings in the columns in the downstream unit) or in catalysts in a downstream renewable diesel unit. The process employs a separate polyethylene (PE) removal to achieve low level of polyethylene (e.g. <50 wt. ppm PE or <20 wt. ppm PE).

The process is a flexible process as it can be easily implemented or performed either at an upstream or at a downstream of pretreatment process (e.g. at degumming and bleaching steps). The process is a part of an overall pretreatment or purification process of the oil or fat feedstock feed in order to make these feeds suitable for feeding to a downstream renewable fuel (e.g. a renewable diesel, a renewable jet fuel, a renewable naphtha) plant. This type of renewable fuel plants are known as Hydrogenated Vegetable Oil (HVO) plant.

The process employs a separate polymer removal unit, in addition to degumming and bleaching, which can be installed within the overall pretreatment or purification plant. The process with a separate polymer-removal enables the reuse of filter cake (e.g. a bleaching earth filter cake) without contaminating the polymer depleted oil or fat feedstock with polymer by again dissolving the polymer into the crude oil or fat feedstock. During de-oiling of the filter cake from bleaching, only a relatively smaller contamination of PE present in the oil.

The process performs a cold filtration step, where the oil or fat feedstock comprising the polymer is cooled in a controlled way to within a certain temperature range, and thereafter it is passed through a filtration process. Typically, above a certain temperature, the polymer remains dissolved in the crude oil or fat feedstock, therefore making it difficult to separate. After performing the cooling step (e1) (i.e. cooling the crude oil or fat feedstock to below a certain temperature), the polymer is not anymore soluble in the oil or fat feedstock. Therefore, the polymer precipitates out of the liquid oil phase, and facilitates a downstream filtration step for the removal of the polymer through a filter cake.

Optionally, the degumming is a process for removal of gums/phosphorus content from the crude oil or fat feedstock by adding phosphoric acid. There are generally two different types of phospholipids present in the crude oil or fat feedstock, i.e. hydratable treated by water degumming, and non-hydratable treated by acid degumming. The acid-degumming process is a variant of the water-degumming process in that it uses a combination of acid and water. The acid degumming process leads to a lower residual phosphorus content than water degumming. The nonhydratable gums can be conditioned into hydratable forms with a degumming acid (e.g. phosphoric acid, citric acid).

Optionally, the degumming conditions comprise (i) contacting with the at least one degumming agent comprising: an acid agent, preferably citric and/or phosphoric acid; a basic agent, preferably caustic soda; or water; and (ii) filtering off the degumming agent after contacting to obtain the degummed feedstock.

Optionally, the bleaching is a step in the process of refining oil or fat feedstock. In the bleaching step, the bleaching agent is applied to the crude oil or fat feedstock, thereby minimizing its content of heavy metals, sulphur, pigments (e.g. carotenes and chlorophylls), and the phosphorus remaining after the degumming step.

Optionally, the crude oil or fat feedstock comprises at least one element selected from the group comprising:

natural oils and fats, waste oils and fats, pretreated oils and fats, used cooking oil, tallow, palm oil mill effluent, palm oil fatty acid distillate, pongamia oil, cashew nut shell liquid, salicorna oil, or tall oil.

Optionally, the polymer concentration in the crude oil or fat feedstock equals or is higher than 100 weight-parts per million (wt.ppm), preferably equals or is higher than 1000 wt.ppm. Optionally, the polymer comprises at least one compound selected from the group comprising: polyethylene, polypropylene, polyimide, ethylene-(vinyl alcohol)-copolymer, polyethylene terephthalate (PET), or polyurethane.

Optionally, the polymer concentration in the polymer depleted oil or fat feedstock equals or is lower than 50 wt.-ppm, preferably equals or is lower than 20 wt.-ppm, most preferably equals or is lower than 10 wt.-ppm.

Optionally, the cooling step in substep (e1) comprises cooling an oil or fat feedstock obtained from an upstream process step (a), (b) or (c) to a temperature between the cloud point temperature of the oil or fat feedstock and 70° C., preferably to a temperature between the cloud point temperature of the oil or fat feedstock and 50° C. After cooling, the oil is still above the cloud point temperature in liquid phase, but the polymers are not anymore dissolved in the oil in this low cloud point temperature, and thereby separating out the polymers from the liquid phase in solid form (e.g. as filter cake). The cooling step in substep (e1) can be performed in one step using cooling water, a chiller or a brine system. The chiller system may be a device that removes heat from the oil or fat feedstock via a vapor-compression, adsorption refrigeration, or absorption refrigeration cycles. The brine systems may use a high concentration of salt water or other anti-freeze solution which is chilled, then pumped around to do the required cooling. The common brines used for refrigeration are sodium chloride (i.e. common salt), calcium chloride and various glycol solutions. Further, in one step cooling, there is a possibility of very small crystal type particle formation which is difficult to remove.

Optionally, the cooling step in substep (e1) is performed in at least two steps. For example, the oil or fat feedstock obtained from the upstream process step (a), (b) or (c) are cooled to a temperature between the cloud point temperature of the oil or fat feedstock using cooling water first and then finally by the chiller system.

Optionally, the temperature of the cooled oil or fat feedstock after the last cooling step is between the cloud point temperature of the oil or fat feedstock and 70° C., preferably between the cloud point temperature of the oil or fat feedstock and 50° C.

Optionally, the cooling step (e1) is performed upstream of the storage volume and/or downstream of the storage volume and/or in the storage volume. For example, if the polymer removal unit is installed at the upstream of the degumming step, the crude oil or fat feedstock is fed to this polymer removal unit from the storage volume/tank, then the additional cooling may not be required.

Optionally, the process comprises adding at least one filter aid chemical to the cooled oil or fat feedstock in step (e2) is performed at atmospheric pressure at a ratio between and including 5 and 15 kg of filter aid chemical per 1000 kg of oil or fat feedstock. This enables the polymer to be agglomerated with the filter aid chemical so that it can be removed during filtration process.

Upon adequate mixing of the cooled oil or fat feedstock with the at least one filter aid chemical, the mixture is transferred to pressure leaf filters via slurry pumps. The polymer from the cooled oil or fat feedstock and the at least one filter aid chemical are filtered and removed as a filter cake in the filtration process. The pressure leaf filters and the slurry pumps are interchangeable with bleaching filtration for flexibility. The pressure leaf filters can be a vertical pressure leaf filter, a horizontal pressure leaf filter or any other type of suitable filters. The resultant polymer depleted oil or fat feedstock may be transferred to final fine filters/polishing filters, and then collected in a receiver. The polymer depleted oil or fat feedstock is then transferred to the storage volume via transfer pumps.

Optionally, the filter aid chemical comprises at least one element from the group comprising:

flux calcined diatomaceous earth, kieselgur, perlite, cellulosic based filter aids, or wood based filter aids.

Optionally, the degumming agent comprises at least one element selected from the group comprising:

an acid agent, preferably citric and/or phosphoric acid; a basic agent, preferably caustic soda; or water.

Optionally, the bleaching conditions comprise:

contacting with a bleaching agent comprising at least one element selected from the group comprising: bleaching earth, silica gel, filter aid;

filtering off the bleaching agent after contacting to obtain the bleached feedstock; and optionally adding nitrogen or steam.

Optionally, the step (e) is performed upstream of step (b) and/or upstream of step (d).

Optionally, the step (e) is performed on the full volume of the oil or fat feedstock before the oil or fat feedstock is introduced into any of the downstream process steps (a), (b), (c) or (d).

Optionally, the process includes a free fatty acid (FFA) removal step and an oil splitting step.

Optionally, the free fatty acid (FFA) removal refers to a process of removing the free fatty acids from the oil or fat feedstock by adding an alkali catalyst (e.g. NaOH, KOH or NH₃) dissolved in hot glycerine (90-95° C.) in order to prevent ester formation.

The term “free fatty acid (FFA) removal step” is to be understood as meaning a pretreatment process step that involves removal of free fatty acid from the crude oil or fat feedstock. The term “free fatty acid (FFA) removal conditions” is to be understood as meaning process conditions such temperature, pressure, p^{H} etc. under such conditions the free fatty acid (FFA) removal step is performed. Optionally, the free fatty acid (FFA) removal step includes at least one of enzymatic esterification, chemical esterification, supercritical extraction, membrane separation, liquid-liquid extraction, or stripping.

The free fatty acid (FFA) removal conditions may include contacting the bleached oil or fat feedstock and/or the polymer depleted oil or fat feedstock with a free fatty acid (FFA) removal agent. The term “free fatty acid depleted oil or fat feedstock” is to be understood as meaning a refined feedstock that is depleted in free fatty acid (FFA) by the free fatty acid (FFA) removal step.

Optionally, the oil splitting step (or hydrolysis) refers to a process that is performed with high pressure steam, resulting in the formation of crude split of fatty acids and crude glycerin dissolved in the excess water. The term “oil splitting step” is to be understood as meaning a pretreatment process step that involves hydrolyzing or splitting the triglycerides in the crude oil or fat feedstock into fatty acids and glycerine. The term “oil splitting conditions” is to be understood as meaning process conditions such temperature, pressure, p^{H} etc. under such conditions the oil splitting step is performed.

The term “oil split feedstock” is to be understood as meaning a refined feedstock where the triglycerides hydrolyzed into fatty acids and glycerine and removed from the crude oil or fat feedstock.

According to a second aspect, the present disclosure provides use of the pretreated oil or fat product as feedstock for a hydrotreatment of vegetable oils or fats to obtain a hydrotreated vegetable oil (HVO) or fat product.

According to a third aspect, the present disclosure provides an apparatus for producing a pretreated oil or fat product from a crude oil or fat feedstock comprising a polymer, wherein the apparatus comprises:
(a) a storage volume and means for providing the crude oil or fat feedstock comprising a polymer from the storage volume;
(b) means for subjecting the crude oil or fat feedstock to a degumming step to obtain a degummed oil or fat feedstock by contacting the crude oil or fat feedstock with at least one degumming agent under degumming conditions;
(c) means for subjecting the degummed oil or fat feedstock to a bleaching step to obtain a bleached oil or fat feedstock by contacting the degummed oil or fat feedstock with at least one bleaching agent under bleaching conditions;
(d) means for routing out the bleached oil or fat feedstock from the bleaching step as the pretreated oil or fat product, and

characterized in that the apparatus further comprises means for performing a polymer removal step (e), performed on the oil and fat feedstock upstream of any of the process steps (a), (b), (c), (d), wherein the means for performing the polymer removal step comprise the following elements:
(e1) means for subjecting the oil or fat feedstock to a cooling step to obtain a cooled oil or fat feedstock,
(e2) means for adding at least one filter aid chemical to the cooled oil or fat feedstock to obtain a cooled filter aid comprising oil or fat feedstock,
(e3) means for subjecting the cooled filter aid comprising oil or fat feedstock to a filtering step to obtain a polymer depleted oil or fat feedstock, and
(e4) means for routing out the polymer depleted oil or fat feedstock and means for introducing the polymer depleted oil or fat feedstock into any of the means for performing a downstream process step (a), (b), (c) or (d).

The apparatus for producing the pretreated oil or fat product from the crude oil or fat feedstock comprising the polymer according to present disclosure is of advantage in that the apparatus performs the removal of polymers (e.g. polyethylene) which is present in the oil or fat feedstock, thereby reducing maintenance requirement and reducing plant shutdown/downtime in downstream units. Further, the apparatus employs a separate polyethylene (PE) removal unit to achieve low level of polyethylene (e.g. <50 wt. ppm PE or <20 wt. ppm PE). The apparatus with the separate polymer-removal unit enables the reuse of filter cake (e.g. a bleaching earth filter cake) without contaminating the polymer depleted oil or fat feedstock with polymer by again dissolving the polymer into the crude oil or fat feedstock. The apparatus is a flexible as it can be easily implemented either at an upstream or at a downstream of pretreatment plant (e.g. at degumming and bleaching steps) plant. The advantage and embodiment of the above process apply mutatis mutandis to the apparatus.

Optionally, the degumming refers to a process for removal of gums/phosphorus content from the crude oil or fat feedstock by adding phosphoric acid. Optionally, the degumming conditions comprises (i) contacting with the at least one degumming agent comprising: an acid agent; preferably citric and/or phosphoric acid; a basic agent, preferably caustic soda; or water; and (ii) filtering off the degumming agent after contacting to obtain the degummed feedstock.

Optionally, the bleaching refers to a step in the process of refining oil or fat feedstock. In the bleaching step, the bleaching agent is applied to the crude oil or fat feedstock, thereby minimizing its content of heavy metals, sulphur, pigments (e.g. carotenes and chlorophylls), and the phosphorus remaining after the degumming step.

The conditions required for performing the following standard oil or fat processing operations: degumming, bleaching, free fatty acid (FFA) removal, oil splitting, polyethylene removal, are known to the skilled person from the prior art. These are the physicochemical conditions under which a measurable, at least partial, preferably an industrially relevant, conversion of a crude oil or fat the corresponding processed oil or fat product is achieved. Necessary adjustments of these processing conditions to the respective operational requirements will be made on the basis of routine experiments. Any specific reaction conditions disclosed may serve here as a guide, but they should not be regarded as limiting in relation to the scope of the invention.

A means is to be understood as meaning something that enables or is helpful in the achievement of a goal. In particular, means for performing a particular process step, as mentioned above, are to be understood as including all physical articles that would be considered by a person skilled in the art in order to be able to perform this process step. For example, a person skilled in the art will consider means of introducing or discharging a material stream to include all transporting and conveying apparatuses, i.e. for example pipe-lines, pumps, compressors, valves, which seem necessary or sensible to said skilled person for performance of this process step on the basis of his knowledge of the art. Pressure indications are in bar, absolute, bar (a) or bara for short, unless otherwise stated in the particular context.

Embodiments of the present disclosure substantially eliminate or at least partially address the aforementioned technical drawbacks in existing technologies by providing the process and apparatus for producing the polymer depleted pretreated oil or fat product from the crude oil or fat feedstock,

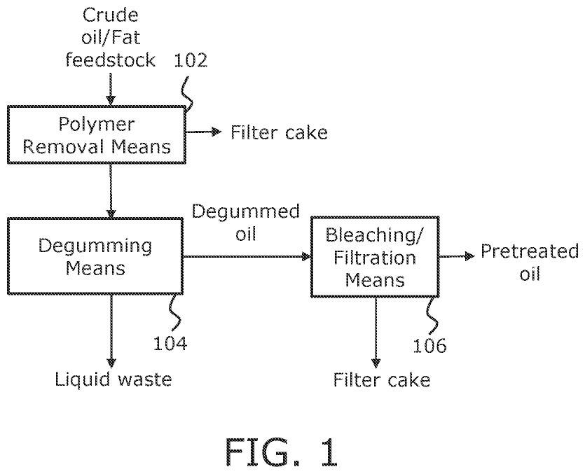

FIG. 1 illustrates a block diagram of an apparatus having a polymer removal means in the upstream of a degumming means for producing a pretreated oil or fat product from a crude oil or fat feedstock comprising a polymer according to an embodiment of the present disclosure. The apparatus includes a polymer removal means 102, a degumming means 104, and a bleaching/filtration means 106. The polymer removal means 102 receives the crude oil or fat feedstock comprising the polymer from a storage volume/tank and performs a polymer removal step on the crude oil or fat feedstock.

The polymer removal means 102 comprises the following elements: (i) means for subjecting the oil or fat feedstock to a cooling step to obtain a cooled oil or fat feedstock, (ii) means for adding at least one filter aid chemical to the cooled oil or fat feedstock to obtain a cooled filter aid comprising oil or fat feedstock, (iii) means for subjecting the cooled filter aid comprising oil or fat feedstock to a filtering step to obtain a polymer depleted oil or fat feedstock, (iv) means for routing out the polymer depleted oil or fat feedstock. At the polymer removal step, the polymers are separated out the removal from the oil or fat feedstock as a filter cake.

The degumming means 104 receives the polymer depleted oil or fat feedstock and performs a degumming step to obtain a degummed oil or fat feedstock by contacting the polymer depleted oil or fat feedstock with at least one degumming agent under degumming conditions. Further, at the degumming step, the liquid waste may be separated out from the polymer depleted oil or fat feedstock after degumming. The bleaching means 106 receives the degummed oil or fat feedstock and performs a bleaching step to obtain a bleached oil or fat feedstock by contacting the degummed oil or fat feedstock with at least one bleaching agent under bleaching conditions. The bleached oil or fat feedstock are routed out from the bleaching means 106 as the pretreated oil or fat product using a routing means. Optionally, the polymer from the bleached oil or fat feedstock are filtered and removed as a filter cake during a filtration process.

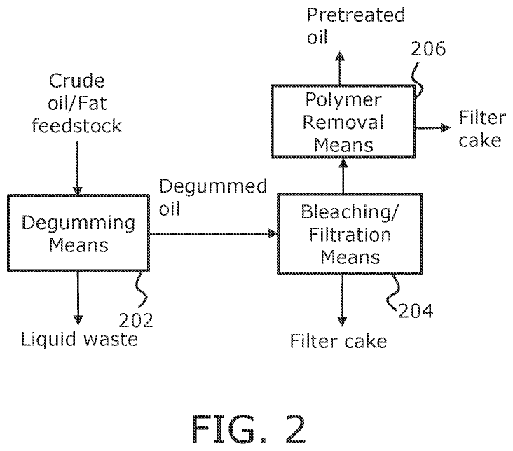

FIG. 2 illustrates a block diagram of an apparatus having a polymer removal means in the downstream of a bleaching means for producing a pretreated oil or fat product from a crude oil or fat feedstock comprising a polymer according to an embodiment of the present disclosure. The apparatus includes a degumming means 202, and a bleaching/filtration means 204, and a polymer removal means 206.

The degumming means 202 receives the crude oil or fat feedstock comprising the polymer from a storage volume/tank. The degumming means 202 performs a degumming step to obtain a degummed oil or fat feedstock by contacting the crude oil or fat feedstock with at least one degumming agent under degumming conditions. Further, at the degumming step, the liquid waste may be separated out from the crude oil or fat feedstock after degumming. The bleaching/filtration means 204 receives the degummed oil or fat feedstock and performs a bleaching step to obtain a bleached oil or fat feedstock by contacting the degummed oil or fat feedstock with at least one bleaching agent under bleaching conditions. The bleached oil or fat feedstock are then routed out from the bleaching step as the pretreated oil or fat product using a routing means. Optionally, the polymer from the bleached oil or fat feedstock is filtered and removed as a filter cake during a filtration process.

The polymer removal means 206 performs a polymer removal step on the oil and fat feedstock. The polymer removal means 206 comprises the following elements; (i) means for subjecting the oil or fat feedstock to a cooling step to obtain a cooled oil or fat feedstock, (ii) means for adding at least one filter aid chemical to the cooled oil or fat feedstock to obtain a cooled filter aid comprising oil or fat feedstock, (iii) means for subjecting the cooled filter aid comprising oil or fat feedstock to a filtering step to obtain a polymer depleted oil or fat feedstock, (iv) means for routing out the polymer depleted oil or fat feedstock. At the polymer removal step, the polymers are separated out the removal from the oil or fat feedstock as a filter cake.

Optionally, the polymer removal step is performed on the oil and fat feedstock upstream of the bleaching step.

A means is to be understood as meaning something that enables or is helpful in the achievement of a goal. In particular, means for performing a particular process step, as mentioned above, are to be understood as including all physical articles that would be considered by a person skilled in the art in order to be able to perform this process step. For example, a person skilled in the art will consider means of introducing or discharging a material stream to include all transporting and conveying apparatuses, i.e. for example pipe-lines, pumps, compressors, valves, which seem necessary or sensible to said skilled person for performance of this process step on the basis of his knowledge of the art.

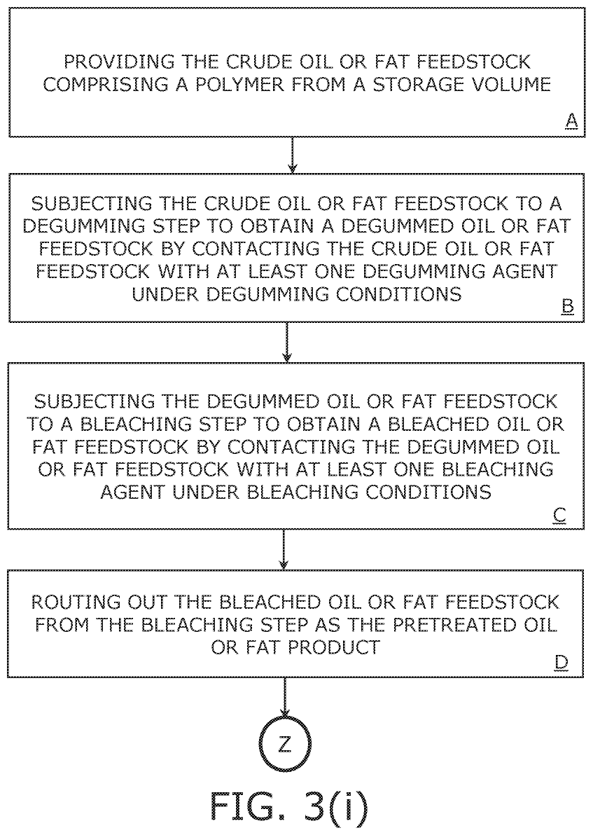

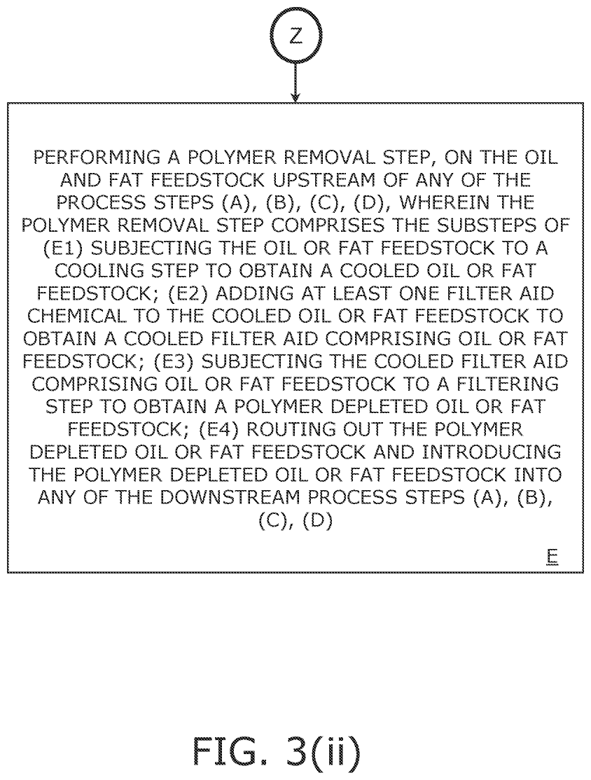

FIGS. 3(i)-3(ii) are flowcharts illustrating a process for producing a pretreated oil or fat product from a crude oil or fat feedstock comprising a polymer according to an embodiment of the present disclosure. At a step A, the crude oil or fat feedstock comprising a polymer is provided from a storage volume. At a step B, the crude oil or fat feedstock is subjected to a degumming step to obtain a degummed oil or fat feedstock by contacting the crude oil or fat feedstock with at least one degumming agent under degumming conditions. At a step C, the degummed oil or fat feedstock is subjected to a bleaching step to obtain a bleached oil or fat feedstock by contacting the degummed oil or fat feedstock with at least one bleaching agent under bleaching conditions. At a step D, the bleached oil or fat feedstock is routed out from the bleaching step as the pretreated oil or fat product. The process further comprises a polymer removal step (E), performed on the oil and fat feedstock upstream of any of the process steps (A), (B), (C), (D). The polymer removal step comprises the substeps of: (E1) subjecting the oil or fat feedstock to a cooling step to obtain a cooled oil or fat feedstock; (E2) adding at least one filter aid chemical to the cooled oil or fat feedstock to obtain a cooled filter aid comprising oil or fat feedstock; (E3) subjecting the cooled filter aid comprising oil or fat feedstock to a filtering step to obtain a polymer depleted oil or fat feedstock; (E4) routing out the polymer depleted oil or fat feedstock and introducing the polymer depleted oil or fat feedstock into any of the downstream process steps (A), (B), (C), (D).

Optionally, the crude oil or fat feedstock comprises at least one element selected from the group comprising: natural oils and fats, waste oils and fats, pretreated oils and fats, used cooking oil, tallow, palm oil mill effluent, palm oil fatty acid distillate, pongamia oil, cashew nut shell liquid, salicorna oil, tall oil. Optionally, the polymer concentration in the crude oil or fat feedstock equals or is higher than 100 wt.ppm, preferably equals or is higher than 1000 wt.ppm.

Optionally, the polymer comprises at least one compound selected from the group comprising: polyethylene, polypropylene, polyamide, ethylene-(vinyl alcohol)-copolymer, polyethylene terephthalate (PET), polyurethane. Optionally, the polymer concentration in the polymer depleted oil or fat feedstock equals or is lower than 50 wt.-ppm, preferably equals or is lower than 20 wt.-ppm, most preferably equals or is lower than 10 wt.-ppm.

Optionally, the cooling step in substep (E1) comprises cooling an oil or fat feedstock obtained from an upstream process step (A), (B) or (C) to a temperature between the cloud point temperature of the oil or fat feedstock and 70° C., preferably to a temperature between the cloud point temperature of the oil or fat feedstock and 50° C. Optionally, the cooling step in substep (E1) is performed in at least two steps. Optionally, the cooled oil or fat feedstock after the last cooling step is between the cloud point temperature of the oil or fat feedstock and 70° C., preferably between the cloud point temperature of the oil or fat feedstock and 50° C. Optionally, the cooling step (E1) is performed upstream of the storage volume and/or downstream of the storage volume and/or in the storage volume.

Optionally, the process comprises adding at least one filter aid chemical to the cooled oil or fat feedstock in step (E2) is performed at atmospheric pressure at a ratio between and including 5 and 15 kg of filter aid chemical per 1000 kg of oil or fat feedstock.

Optionally, the filter aid chemical comprises at least one element from the group comprising: flux calcined diatomaceous earth, kieselgur, perlite, cellulosic based filter aids, wood based filter aids. Optionally, the degumming agent comprises at least one element selected from the group comprising: an acid agent, preferably citric and/or phosphoric acid; a basic agent, preferably caustic soda; water.

Optionally, the bleaching conditions comprise (i) contacting with a bleaching agent comprising at least one element selected from the group comprising bleaching earth, silica gel, filter aid, (ii) filtering off the bleaching agent after contacting to obtain the bleached feedstock, and (iii) optionally adding nitrogen or steam.

Optionally, the step (E) is performed upstream of step (B) and/or upstream of step (D).

Optionally, the step (E) is performed on the full volume of the oil or fat feedstock before the oil or fat feedstock is introduced into any of the downstream process steps (A), (B), (C) or (D).

Modifications to embodiments of the present disclosure described in the foregoing are possible without departing from the scope of the present disclosure as defined by the accompanying claims, Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural.

### LIST OF REFERENCE NUMERALS

102—polymer removal means
104—degumming means
106—bleaching/filtration means
202—degumming means
204—bleaching/filtration means
206—polymer removal means

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process for producing a pretreated oil or fat product from a crude oil or fat feedstock comprising a polymer, the process comprising the following steps:
(a) providing the crude oil or fat feedstock comprising a polymer from a storage volume;
(b) subjecting the crude oil or fat feedstock to a degumming step to obtain a degummed oil or fat feedstock by contacting the crude oil or fat feedstock with at least one degumming agent under degumming conditions;
(c) subjecting the degummed oil or fat feedstock to a bleaching step to obtain a bleached oil or fat feedstock by contacting the degummed oil or fat feedstock with at least one bleaching agent under bleaching conditions;
(d) routing out the bleached oil or fat feedstock from the bleaching step as the pretreated oil or fat product;
further comprising a polymer removal step (e), performed on the oil and fat feedstock upstream of any of the process steps (a), (b), (c), (d), wherein the polymer removal step comprises the sub-steps of:
(e1) subjecting the oil or fat feedstock to a cooling step to obtain a cooled oil or fat feedstock;
(e2) adding at least one filter aid chemical to the cooled oil or fat feedstock to obtain a cooled filter aid comprising oil or fat feedstock;
(e3) subjecting the cooled filter aid comprising oil or fat feedstock to a filtering step to obtain a polymer depleted oil or fat feedstock; and
(e4) routing out the polymer depleted oil or fat feedstock and introducing the polymer depleted oil or fat feedstock into any of the downstream process steps (a), (b), (c), (d).

2. The process according to claim 1, wherein the crude oil or fat feedstock comprises at least one element selected from the group consisting of:
natural oils and fats, waste oils and fats, pretreated oils and fats, used cooking oil, tallow, palm oil mill effluent, palm oil fatty acid distillate, pongamia oil, cashew nut shell liquid, salicorna oil, and tall oil.

3. The process according to claim 1, wherein the polymer concentration in the crude oil or fat feedstock equals or is higher than 100 weight-parts per million (wt.ppm).

4. The process according to claim 1, wherein the polymer comprises at least one compound selected from the group consisting of:
polyethylene, polypropylene, polyamide, ethylene-(vinyl alcohol)-copolymer, polyethylene terephthalate (PET), and polyurethane.

5. The process according to claim 1, wherein the polymer concentration in the polymer depleted oil or fat feedstock equals or is lower than 50 wt.-ppm.

6. The process according to claim 1, wherein the cooling step in substep (e1) comprises coding an oil or fat feedstock obtained from an upstream process step (a), (b) or (c) to a temperature between the cloud point temperature of the oil or fat feedstock and 70° C.

7. The process according to claim 1, wherein the coding step in substep (et) is performed in at least two steps.

8. The process according to claim 7, wherein the temperature of the coded oil or fat feedstock after the last cooling step is between the cloud point temperature of the oil or fat feedstock and 70° C.

9. The process according to claim 1, wherein the coding step (e1) is performed upstream of the storage volume and/or downstream of the storage volume and/or in the storage volume.

10. The process according to claim 1, wherein adding at least one filter aid chemical to the coded oil or fat feedstock in step (e2) is performed at atmospheric pressure at a ratio between and including 5 and 15 kg of filter aid chemical per 1000 kg of oil or fat feedstock.

11. The process according to claim 1, wherein the filter aid chemical comprises at least one element from the group consisting of:
flux calcined diatomaceous earth, kieselgur, perlite, cellulosic based filter aids, and wood based filter aids.

12. The process according to claim 1, wherein the degumming agent comprises at least one element selected from the group consisting of:
an acid agent, preferably citric and/or phosphoric acid; a basic agent, preferably caustic soda; and water.

13. The process according to claim 1, wherein the bleaching conditions comprise:
contacting with a bleaching agent comprising at least one element selected from the group comprising: bleaching earth, silica gel, filter aid;
filtering off the bleaching agent after contacting to obtain the bleached feedstock; and
adding nitrogen or steam.

14. The process according to claim 1, wherein step (e) is performed upstream of step (b) and/or upstream of step (d).

15. The process according to claim 1, wherein step (e) is performed on the full volume of the oil or fat feedstock before the oil or fat feedstock is introduced into any of the downstream process steps (a), (b), (c) or (d).

16. An apparatus for producing a pretreated oil or fat product from a crude oil or fat feedstock comprising a polymer, wherein the apparatus comprises:
(a) a storage volume and means for providing the crude oil or fat feedstock comprising a polymer from the storage volume;
(b) a means for subjecting the crude oil or fat feedstock to a degumming step to obtain a degummed oil or fat feedstock by contacting the crude oil or fat feedstock with at least one degumming agent under degumming conditions;
(c) a means for subjecting the degummed oil or fat feedstock to a bleaching step to obtain a bleached oil or fat feedstock by contacting the degummed oil or fat feedstock with at least one bleaching agent under bleaching conditions;
(d) a means for routing out the bleached oil or fat feedstock from the bleaching step as the pretreated oil or fat product, and
further comprising a means for performing a polymer removal step (e), performed on the oil and fat feedstock upstream of any of the process steps (a), (b), (c), (d), wherein the means for performing the polymer removal step comprise the following elements;
(e1) a means for subjecting the oil or fat feedstock to a cooling step to obtain a cooled oil or fat feedstock,
(e2) a means for adding at least one filter aid chemical to the cooled oil or fat feedstock to obtain a cooled filter aid comprising oil or fat feedstock,
(e3) a means for subjecting the cooled filter aid comprising oil or fat feedstock to a filtering step to obtain a polymer depleted oil or fat feedstock, and
(e4) a means for routing out the polymer depleted oil or fat feedstock and means for introducing the polymer depleted oil or fat feedstock into any of the means for performing a downstream process step (a), (b), (c) or (d).
